(19) United States
(12) Patent Application Publication
(10) Pub. No.: US 2008/0283697 A1
(43) Pub. Date: Nov. 20, 2008

(54) APPARATUSES AND SYSTEMS FOR SUPPORTING AND POSITIONING CAMERAS AND OTHER EQUIPMENT

(76) Inventor: Richard Darrow, Denville, NJ (US)

Correspondence Address: PERKINS COIE LLP;PATENT-SEA, P.O. BOX 1247, SEATTLE, WA, 98111-1247, US

(21) Appl. No.: 12/119,455

(22) Filed: May 12, 2008

Related U.S. Application Data
(63) Continuation-in-part of application No. 12/148,948, filed on Apr. 23, 2008.
Application No. 12/148,948 is a continuation-in-part of application No. 11/741,545, filed on Apr. 27, 2007.

(51) Int. Cl. F16M 11/00; G03B 17/00

(52) U.S. Cl. 248/163.1; 396/428

(57) ABSTRACT

Apparatuses and systems for supporting and positioning cameras and other equipment are disclosed herein. An apparatus for supporting a camera in accordance with one embodiment of the invention can include one or more bendable support members extending from a camera holding portion. In this embodiment, each of the bendable support members includes a plurality of shaped portions arranged on an elongate, bendable core. Each of the shaped portions can include a plurality of gripping features on an exterior surface thereof.

### CROSS-REFERENCE TO OTHER APPLICATION(S)

The present application is a continuation-in-part of U.S. patent application Ser. No. 12/148,948 entitled “APPARATUSES AND SYSTEMS FOR SUPPORTING AND POSITIONING CAMERAS AND OTHER EQUIPMENT” filed Apr. 23, 2008 (Attorney Docket No. 64091.8002.US01), and a continuation-in-part of U.S. patent application Ser. No. 12/110,239 entitled “APPARATUSES AND SYSTEMS FOR SUPPORTING AND POSITIONING CAMERAS AND OTHER EQUIPMENT” filed Apr. 25, 2008 (Attorney Docket No. 64091.8002.US03), each of which is a continuation-in-part of U.S. patent application Ser. No. 11/741,545 entitled “APPARATUSES AND SYSTEMS FOR SUPPORTING AND POSITIONING CAMERAS AND OTHER EQUIPMENT” filed Apr. 27, 2007, each of which is hereby incorporated by reference in its entirety.

### TECHNICAL FIELD

The following disclosure relates generally to tripods and other portable apparatuses for supporting cameras and other equipment in desired positions and orientations.

### BACKGROUND

There are a number of advantages to using a tripod when taking pictures. For example, a tripod can hold a camera almost perfectly still to enhance picture clarity. Tripods can also support lenses that are too large or unwieldy to be held steadily by hand. In addition, tripods can allow the photographer to get into the picture when used with a timer. Another advantage is that most high quality tripods include interchangeable heads that the photographer to attach a variety of devices, including compact digital cameras, camcorders, DVD recorders, etc.

One shortcoming of conventional tripods, however, is that they typically require a substantially level and stable support surface. As a result, it is often difficult to use conventional tripods on irregular terrain, moving vehicles, etc.

The Joby Gorillapod™, provided by the Joby Corporation of 1535 Mission Street, San Francisco, Calif. 94103, was designed to overcome the shortcomings of conventional tripods. The Gorillapod™ has one to three legs which can be bent and rotated as needed to accommodate an inclined surface or attach to an upstanding structure (see, for example, http://www.joby.com).

FIG. 1A is a cross-sectional view of a portion of a tripod leg 100. The tripod leg 100 is similar to that found on the Gorillapod™, and is composed of a series of interconnecting members 102 (identified individually as interconnecting members 102a-c). Each of the interconnecting members 102 includes a male ball portion 104 and a female socket portion 106. As shown in FIG. 1A, each ball portion 104 is rotatably received in an adjacent socket portion 106. The ball/socket arrangement allows the tripod leg 100 to flex, and the friction between the interlocking balls and sockets holds the leg 100 in a desired position after forming.

One shortcoming of the prior art tripod leg illustrated in FIG. 1A is that if the leg 100 is over-flexed, the ball portions 104 can pull out of the mating socket portions 106, as shown in FIG. 1B. Accordingly, it would be advantageous to have a camera tripod that could be bent to accommodate irregular mounting surfaces without breaking if overflexed.

### BRIEF DESCRIPTION OF THE DRAWINGS

FIG. 1A is a cross-sectional view of a portion of a tripod leg configured in accordance with the prior art, and FIG. 1B is an exploded view of the tripod leg of FIG. 1A.

FIG. 2 is an isometric view of an adjustable camera support configured in accordance with an embodiment of the invention.

FIG. 3 is a partial cross-sectional view of the adjustable camera support of FIG. 2.

FIG. 4 is an isometric view of an adjustable camera support configured in accordance with another embodiment of the invention.

FIG. 5 is a cross-sectional view of the adjustable camera support of FIG. 4.

FIG. 6 is a cross-sectional view of a camera holding portion usable with an adjustable camera support configured in accordance with an embodiment of the invention.

FIG. 7A is an isometric view of an adjustable camera support configured in accordance with another embodiment of the invention.

FIGS. 7B and 7C are enlarged views of portions of the adjustable camera support of FIG. 7A.

FIGS. 8 and 9 are cross-sectional views of portions of adjustable camera supports configured in accordance with embodiments of the invention.

FIG. 10 is a side view of an adjustable camera support configured in accordance with another embodiment of the invention.

FIG. 11A is an isometric view of an adjustable camera support configured in accordance with yet another embodiment of the invention.

FIGS. 11B and 11C are enlarged views of a portion of the camera support of FIG. 11A.

FIGS. 12 and 13 are enlarged cross-sectional views of portions of adjustable camera supports taken substantially along lines 12, 13-12, 13 of FIG. 11A configured in accordance with embodiments of the invention.

FIG. 14 is a side view of an adjustable camera support configured in accordance with yet another embodiment of the invention.

FIG. 15A is an isometric view and FIG. 15B is an isometric cross-sectional view taken substantially along lines 15B-15B of FIG. 15A of an adjustable mounting head configured in accordance with an embodiment of the invention.

FIG. 16A is an isometric view of an adjustable camera support configured in accordance with a further embodiment of the invention.

FIGS. 16B and 16C are enlarged side views of a portion of the camera support of FIG. 16A.

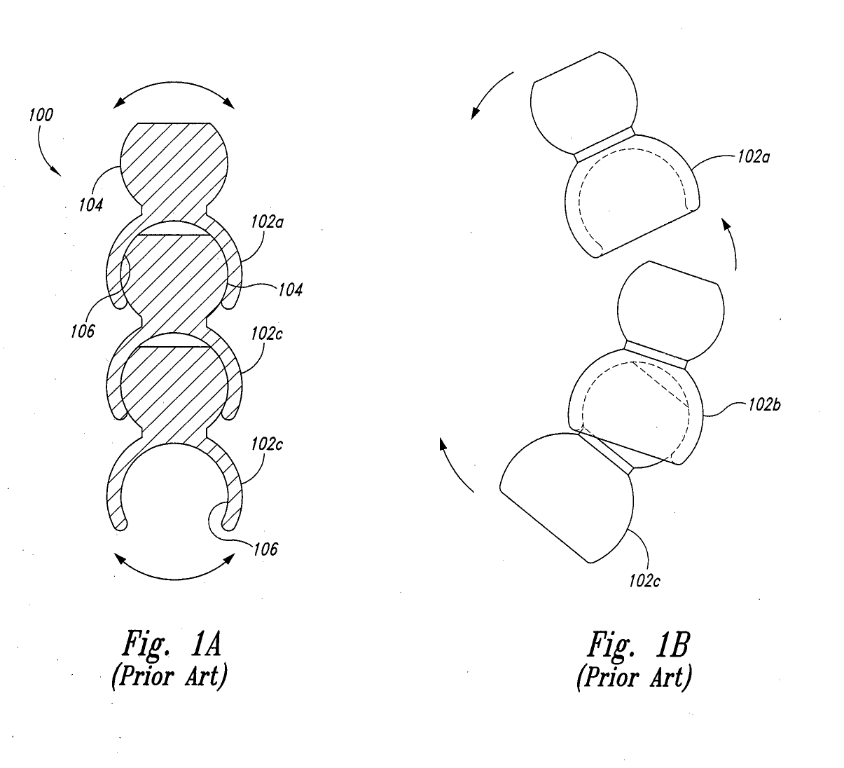

### DETAILED DESCRIPTION

The following disclosure describes various embodiments of apparatuses and systems for supporting and positioning cameras and other equipment in desired locations and/or orientations. In one embodiment, for example, an apparatus for supporting a camera includes an adjustable camera holding portion and a plurality of formable legs. In this embodiment, each of the formable legs includes a first end portion operably coupled to the camera holding portion, and a second end portion spaced apart from the camera holding portion. Each of the formable legs further includes an elongate bendable member extending between the first and second end portions, and a plurality of spherical portions consecutively arranged on the elongated bendable member in the space between the first and second end portions. As described in greater detail below, in one embodiment, the elongate bendable member can include a plastically deformable material and each of the spherical portions can include an elastomeric material.

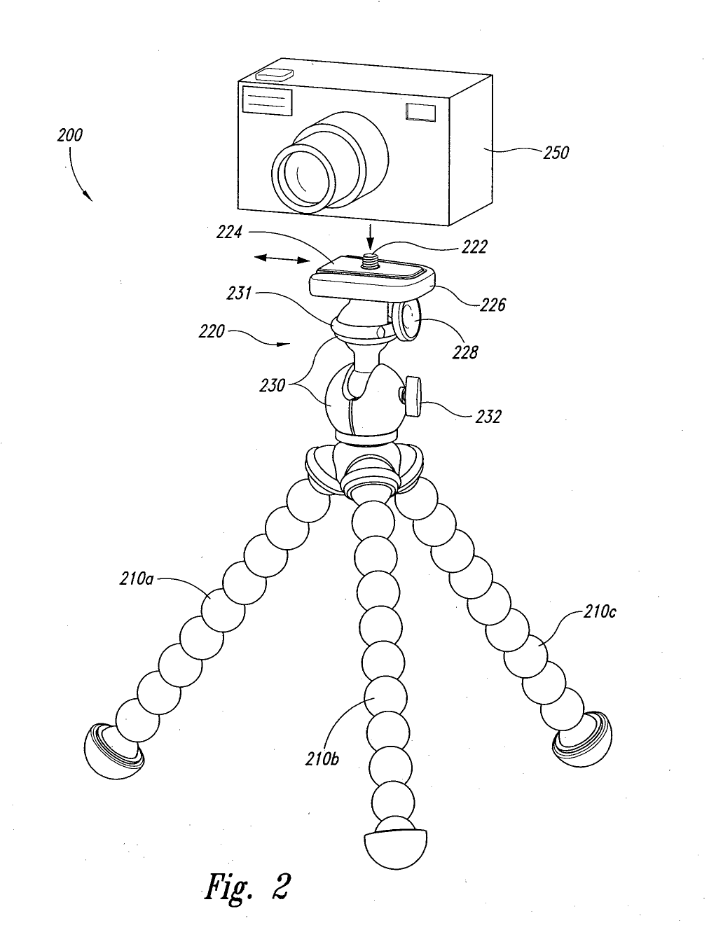

Certain details are set forth in the following description and in FIGS. 2-6 to provide a thorough understanding of various embodiments so the invention. Other details describing well-known structures and systems often associated with camera tripods and other equipment mounting apparatuses, however, are not set forth in the following disclosure to avoid unnecessarily obscuring the description of the various embodiments of the invention.

Many of the details, dimensions, and other features shown in the Figures are merely illustrative of particular embodiments of the invention. Accordingly, other embodiments can have other details, dimensions, and features without departing from the spirit or scope of the present invention. In addition, further embodiments of the invention can be practiced without several of the details described below.

In the Figures, identical reference numbers identify identical, or at least generally similar, elements. To facilitate the discussion of any particular element, the most significant digit or digits of any reference number refer to the Figure in which that element is first introduced. For example, element 210 is first introduced and discussed with reference to FIG. 2.

FIG. 2 is an isometric view of an adjustable camera support apparatus 200 (“support apparatus 200”) configured in accordance with an embodiment of the invention. In one aspect of this embodiment, the apparatus 200 includes a plurality of formable support members or legs 210 (identified individually as a first leg 210a, a second leg 210b, and a third leg 210c) which are pivotally connected to an equipment or camera holding portion 220. The camera holding portion 220 can include an adjustable mounting head 226. The mounting head 226 includes a removable clip 224 which carries a camera engagement feature, such as a threaded stud 122, for releasably engaging a camera 250. The user can disengage the camera 250 from the support apparatus 200 by depressing a button 228 to release the clip 224 from the mounting head 226. The camera holding portion 220 of the illustrated embodiment can further include one or more adjustable joints 230. The joints 230 can accommodate virtually any orientation of the camera 250, and can be releasably locked into a particular position by a first clamping feature 231 (e.g., a rotatable lock-ring) and/or a second clamping feature 232 (e.g., a pinch-bolt).

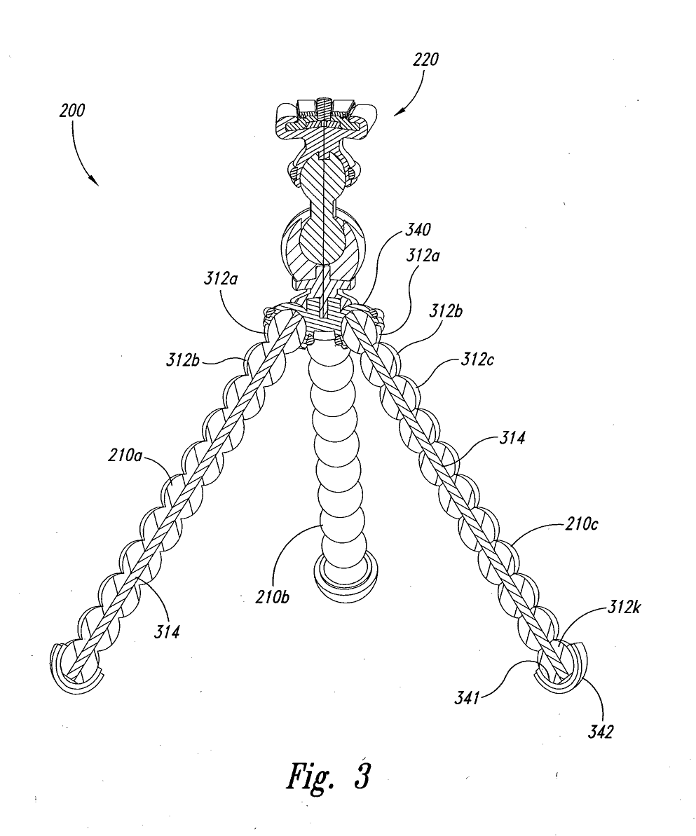

FIG. 3 is a partial cross-sectional view of the camera support apparatus 200 of FIG. 2. As this view illustrates, each of the legs 210 includes a plurality of shaped outer portions 312 (identified individually as shaped outer portions 312a-k) arranged on an elongate, bendable member or core 314. The core 314 can include a plastically deformable material that can be formed or bent into a given shape and remain in that shape without appreciable spring-back. Such materials can include, for example, various types of metals such as aluminum (e.g., 1070 aluminum), copper, steel and other known metals of suitable composition, ductility, heat treat, etc. In other embodiments, the core 314 can be made from other known metal and non-metal materials that can be formed or bent into a given shape and remain in that shape without appreciable spring-back.

In the illustrated embodiment, each of the shaped outer portions 312 has a generally spherical shape and can be made from a suitably compressible and resilient material. For example, in one embodiment, the shaped outer portions 312 can be made from a thermoplastic elastomer (“TPE”). In other embodiments, the shaped outer portions 312 can have other shapes (e.g., ellipsoids, ovaloids, etc.), and can be made from other suitable materials. Such materials can include, for example, other elastomeric materials, such as rubber, some foams, etc., and/or other non-elastomeric materials such as some plastics, wood, etc. In one embodiment, the plurality of shaped outer portions 312 can be integrally formed (e.g., molded) and interconnected, as illustrated by the first leg 210a. In another embodiment, the shaped outer portions 312 can be separately formed as individual pieces and then assembled on the core 314, as illustrated by the third leg 210c.

In the illustrated embodiment, the shaped outer portions 312 are contiguously arranged on the core 314, and each of the shaped outer portions 312 includes an outer surface (e.g. a convex outer surface) that contacts the adjacent outer surface(s) of the adjacent outer portion(s) 312. In other embodiments, however, various types of spacers (not shown) can be positioned between one or more of the shaped outer portions 312 if desired for cost, functional, or other considerations.

In another aspect of this embodiment, the first shaped outer portion 312a is pivotally received in a socket 340 to operably couple the leg 210 to the camera holding portion 220. The last shaped outer portion 312k can be at least partially covered by a cap 341, which in turn can be covered by a non-slip boot 342. The cap 341 can be made from a plastic, such as acrylonitrile butadiene styrene (“ABS”), and the boot 342 can be made from TPE, rubber, or another suitable material.

The bendable core 314 has relatively little or no memory, such that when it is bent into a particular shape it tends to remain in that shape. As a result, the legs 210 can easily be bent or formed into a desired shape to position the camera 250 on irregular terrain, or to attach the camera 250 to a particular object or structure (e.g., a tree limb, a person's body, a vehicle, etc.). Although each of the shaped outer portions 312 is angularly movable relative to the other shaped outer portions, the adjacent shaped outer portions 312 bear against each other at extreme angles to keep the core 114 from being over-bent or kinked. The shaped outer portions 312 can provide a comfortable gripping surface for the user to grasp when bending the leg 210. In addition, the elastomeric and/or compressible properties of the shaped outer portions 312 of the illustrated embodiment can help the apparatus 200 hold on to a structure when wrapped around the structure.

In contrast to conventional tripods having bendable legs, the elongate core 314 of the present invention prevents the leg 210 from coming apart when bent to extreme angles. A further advantage of this embodiment is that shaped outer portions 312 prevent the user from inadvertently over-bending the leg 210 during use.

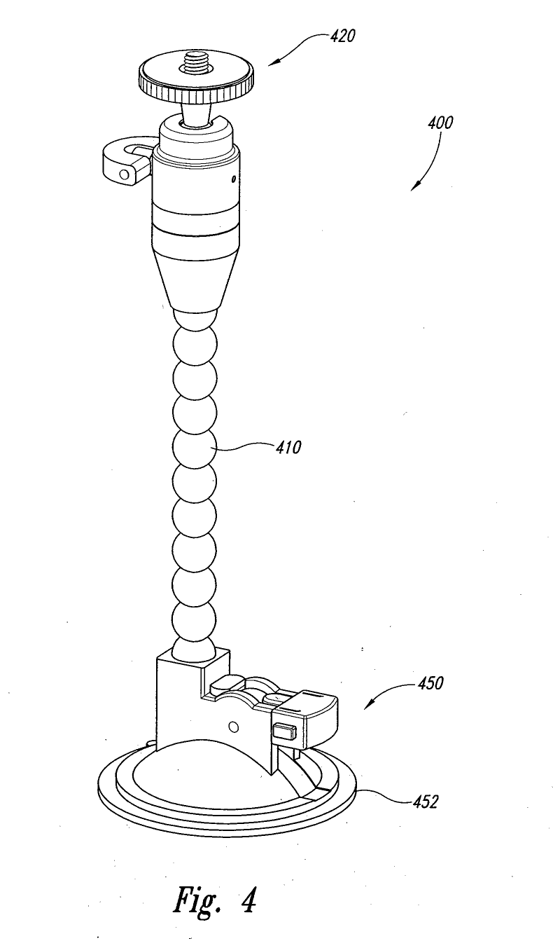

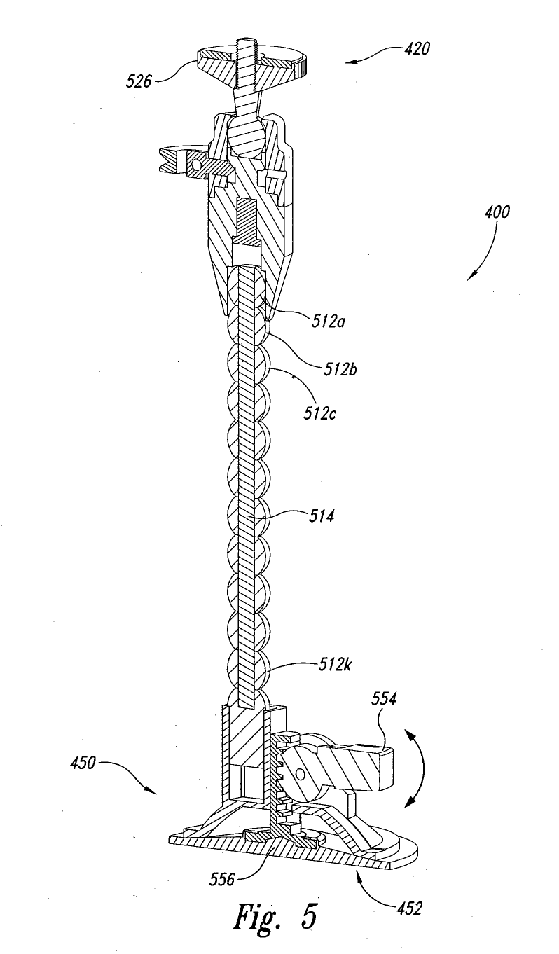

FIG. 4 is an isometric view of a camera support apparatus 400 (“support apparatus 400”) configured in accordance with another embodiment of the invention. Many features of the support apparatus 400 can be at least generally similar in structure and function to the corresponding features of the support apparatus 200 described above with reference to FIGS. 2 and 3. In this particular embodiment, however, the support apparatus 400 includes a camera holding portion 420 supported by a single formable support member or leg 410 in a “monopod” configuration. As described in greater detail below with reference to FIG. 5, the leg 410 extends from a base 450 that includes an attachment feature 452 for releasably attaching the support apparatus 400 to a mounting surface (not shown).

FIG. 5 is a cross-sectional isometric view of the support apparatus 400 of FIG. 4. As this view illustrates, the support leg 410 can be at least generally similar in structure and function to the support legs 210 described above with reference to FIGS. 2 and 3. More specifically, the support leg 410 can include a plurality of shaped outer portions 512 (identified individually as shaped outer portions 512a-k), which are arranged on an elongate, bendable member or core 514. The shaped outer portions 512 and the core 514 can be at least generally similar in structure and function to the shaped outer portions 312 and the core 314, respectively, described above.

In the illustrated embodiment, the base attachment feature 452 includes a suction cup 556 that is operably coupled to an actuator or ratchet 544. The ratchet 544 can be moved in a first direction to attach the suction cup 556 to a suitable surface for use of the apparatus 400. The ratchet 544 can be moved in a second direction to release the suction cup 556 from the surface. In other embodiments, the base 450 can include other means, e.g., magnets, adhesives, etc. for releasably attaching the support apparatus 400 to a desired surface.

In the illustrated embodiment, the camera holding portion 420 includes an adjustable mounting head 526 that can tilt in virtually any direction. In other embodiments, however, the support apparatus 400 can include other types of mounting heads known in the art.

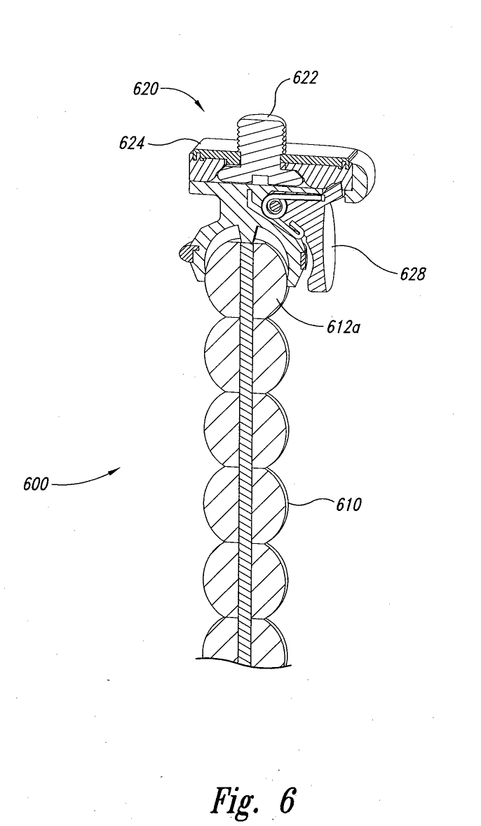

FIG. 6 is a cross-sectional view of a camera holding portion 620 of a camera support apparatus 600 (“support apparatus 600”) configured in accordance with another embodiment of the invention. In the illustrated embodiment, the camera holding portion 620 includes a camera attachment feature, such as a threaded stud 622, which extends upwardly from a camera mounting clip 624 to engage a camera (not shown). As described above with reference to FIG. 2, the camera mounting clip 624 can be released from the camera mounting portion 620 by depressing an associated release button 628. This enables the camera to be easily engaged and disengaged from the support apparatus 600 during use. The camera holding portion 620 of this embodiment also includes a socket 640 that pivotally receives a first shaped outer portion 612a of a bendable leg 610. The camera holding portion 620 is able to gimbal about the shaped outer portion 612a, until locked in a desired position with a clamping feature 631 (e.g., a rotating lock ring).

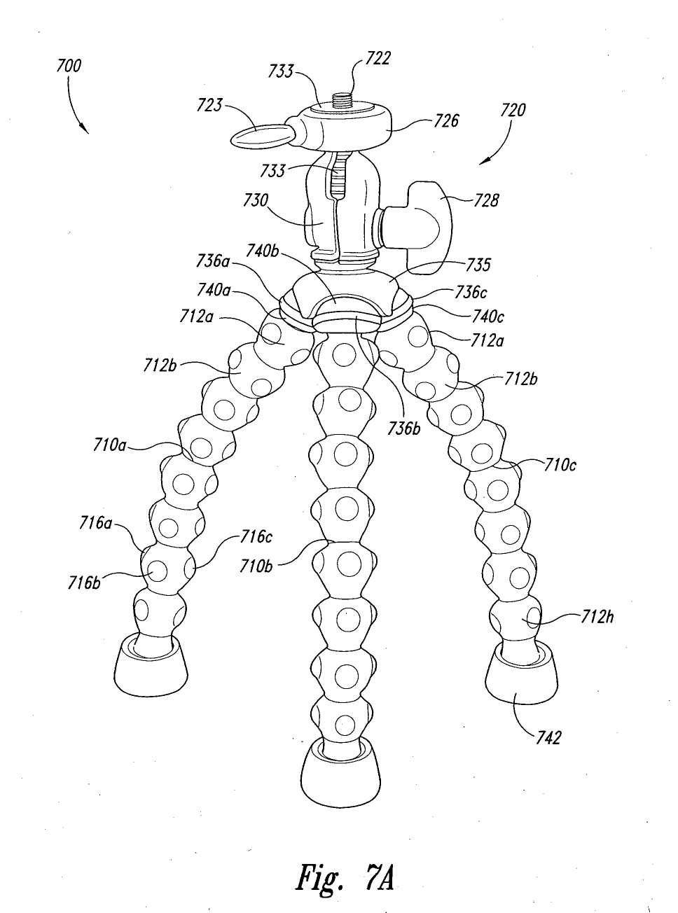

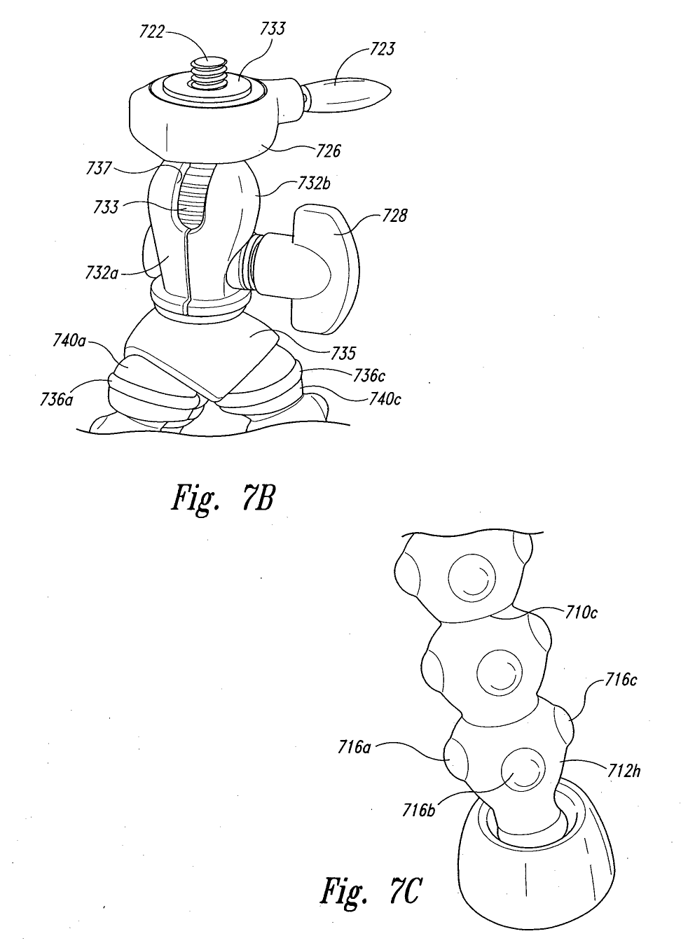

FIG. 7A is an isometric view of an adjustable camera support apparatus 700 (“support apparatus 700”) configured in accordance with another embodiment of the invention. Many features of the support apparatus 700 can be at least generally similar in structure and function to corresponding features of the support apparatuses 200, 400, 600 described above with reference to FIGS. 2-6. For example, the illustrated embodiment includes a plurality of support members or legs 710 (identified individually as a first leg 710a, a second leg 710b, and a third leg 710c) that are pivotally connected to a camera holding portion 720.

FIG. 7B is an enlarged view of the camera holding portion 720 of FIG. 7A. Referring to FIGS. 7A and 7B together, in the illustrated embodiment, the camera holding portion 720 includes an adjustable mounting head 726 operably coupled to an adjustable joint 730 to support a camera. The adjustable mounting head 726 is rotatable relative to the adjustable joint 730, and the adjustable joint 730 is rotatable relative to a base portion 735. For example, in FIG. 7B the adjustable mounting head 726 is rotated to a different position than that shown in FIG. 7A. The base portion 735 includes multiple sockets 740 (identified individually as a first socket 740a, a second socket 740b, and a third socket 740c), each of which pivotally receives a corresponding leg 710. Each socket 740 includes a ring member 736 (identified individually as a first ring member 736a, a second ring member 736b, and a third ring member 736c) received in a groove in the corresponding socket 740. In the illustrated embodiment, each ring member 736 is positioned at an equatorial portion of the socket 740. Each ring member 736 provides a textured surface for gripping the base portion 735 to adjust the camera holding portion 720 and/or legs 710 with reference to the base portion 735.

The adjustable joint 730 includes two clamping portions 732 (identified individually in FIG. 7B as a first clamping portion 732a and a second clamping portion 732b) that surround a support member 733. In the illustrated embodiment, the adjustable joint 730 is configured so that the support member 733 can rotate therein, as well as pivot through a slot 737 formed between the clamping portions 732. When the support member 733 is positioned at a desired orientation, the clamping portions 732 can be releasably locked with reference the support member 733 by a first clamping feature 728 (e.g., a pinch bolt).

The support member 733 extends from the adjustable joint 730 through the mounting head 726. The mounting head 726 is rotatable about the support member 733 and can be releasably locked with reference to the support member 733 by a second clamping feature 723 (e.g., a pinch bolt). A threaded stud 722 extends from the support member 733 for attachment to a camera (not shown). In this manner, the camera holding portion 720 can support and retain a camera in a variety of different positions.

Referring again to FIG. 7A, in the illustrated embodiment each of the legs 710 includes a plurality of shaped outer portions 712 (identified individually as shaped outer portions 712a-712h) arranged on an elongate, bendable member or core (not shown). According to one aspect of the illustrated embodiment, each shaped outer portion 712 can be a body of rotation in which the widest portion of each shaped outer portion 712 can be offset toward one end of the shaped outer portion 712. For example, in certain embodiments each shaped outer portion 712 can be an ovoid or spheroid with an offset equatorial bulge. In other embodiments, each shaped outer portion 712 can have a shape generally similar to an inverted cone, egg, turnip, spinning top, flowerpot, etc. In still further embodiments, the shaped outer portions 712 can include other shapes or configurations, including, for example, spherical, rectilinear, polygonal, irregular, and/or other suitable shapes.

According to another aspect of the illustrated embodiment, each of the shaped outer portions 712 includes a plurality of discrete bumps or protrusions 716 (identified individually as a first protrusion 716a, a second protrusion 716b, and a third protrusion 716c). FIG. 7C is an enlarged view of a base portion of the third leg 710c of FIG. 7A. Referring to FIGS. 7A and 7C together, the protrusions 716 are raised portions that extend from the outer surface of each shaped outer portion 712. In the illustrated embodiment, the protrusions are spaced apart from each other and arranged along a central or equatorial portion of each shaped outer portion 712. In one embodiment, each shaped outer portion 712 can have four equally spaced-apart protrusions 716. In other embodiments, however, there can be a greater or lesser number of protrusions 716 per shaped outer portion 712 that can be arranged in different patterns (e.g., randomly, staggered, etc.).

In the illustrated embodiment, the protrusions 716 have a generally hemispherical shape and can be integrally formed (e.g., molded) with the shaped outer portions 712. The protrusions 716 can be made from the same material as the shaped outer portions 712, including, for example, plastics, thermoplastic elastomers, elastomeric materials, and/or non-elastomeric materials. As described below, however, in another embodiment the protrusions 716 can be formed as individual pieces and then assembled on the shaped outer portions 712. For example, the protrusions 716 can be made from a non-slip material non-slip material (e.g., TPE, rubber, etc.) and be at least partially embedded, adhered, or otherwise attached to the shaped outer portions 712. Moreover, in other embodiments, the protrusions 716 can have other shapes (e.g., pointed, oblong, rectilinear, etc.) extending from the shaped outer portions 712.

The protrusions 716 provide a gripping capability when the support apparatus 700 is attached to a particular object. For example, when the legs 710 are at least partially wrapped around an object (e.g., a bar, tree limb, rock, etc.), the protrusions 716 enhance the gripping capability of the legs 710. Moreover, the protrusions 716 can provide an improved grip on uneven or irregular surfaces. As a result, the protrusions 716 can help to stabilize a camera mounted on a variety of different objects or surfaces with the support surface 700.

According to another feature of the illustrated embodiment, several of the components of the support apparatus 700 can be different colors. In the illustrated embodiment, for example, the shaped outer protrusions 712, or portions thereof can include alternating or contrasting colors. In other embodiments, however, the support apparatus 700 can be a generally uniform color.

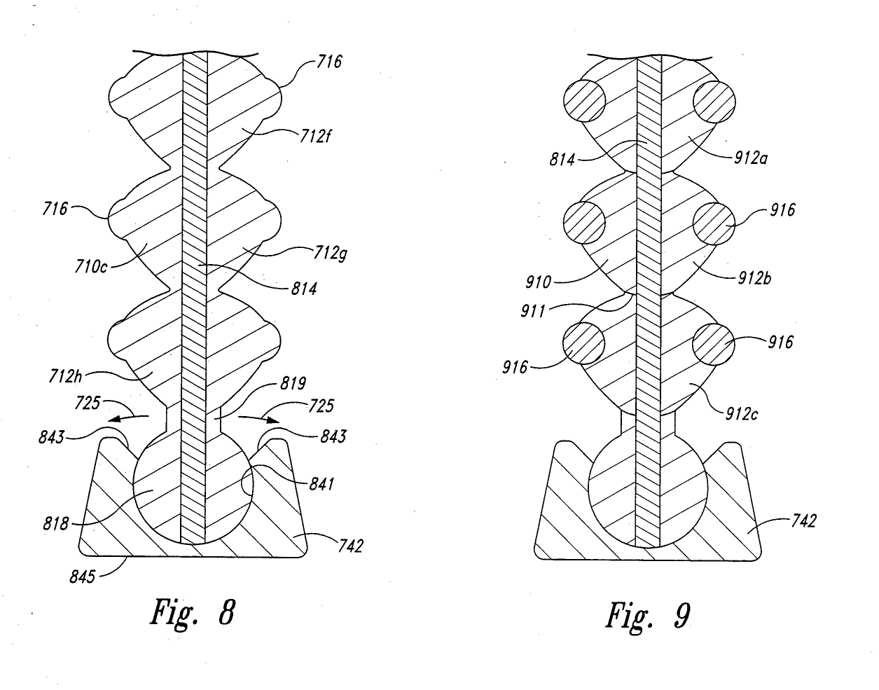

Another feature of the embodiment illustrated in FIGS. 7A and 7C is that the last shaped outer portion 712h of each leg 710 is pivotally coupled to a support socket or foot 742. As explained in detail below with reference to FIG. 8, each foot 742 is configured to be self-leveling with reference to the corresponding leg 710.

FIG. 8 is a cross-sectional side view of a portion of the third leg 710c of FIG. 7C. In the embodiment illustrated in FIG. 8, the shaped outer portions 712 are integrally formed (e.g., molded) with the corresponding protrusions 716.

As shown in FIG. 8, the third leg 710c is pivotally coupled to the foot 742 in a ball-and-socket configuration. For example, the foot 742 has a slanted surface 843 leading to a spherical cavity 841 (e.g., a socket). The third leg 710c includes a spherical end portion 818 spaced apart from the last shaped outer portion 712h by an extension portion 819. The spherical end portion 818 is rotatably received in the spherical cavity 841, and can pivot and/or rotate therein to facilitate alignment of a base surface 845 with a support surface. The slanted surface 843 allows for movement of the extension portion 819 in the directions indicated by arrows 825. For example, as the third leg 710c pivots with reference to the foot 742, the slanted surface 843 provides clearance for movement of the extension portion 819. In one embodiment, each foot 742 can be made from the same materials as the legs 710 (e.g., plastics, thermoplastic elastomers, elastomeric materials, and/or non-elastomeric materials, etc.). In another embodiment, however each foot 742 can include at least a portion made from a non-slip material (e.g., TPE, rubber, etc.).

In the illustrated embodiment, the foot 742 can pivot independently from the third leg 710c to allow the generally planar base surface 845 to be self-leveling with reference to the third leg 710c. For example, if the support apparatus 700 (FIG. 7A) is positioned on a slanted or uneven surface, each foot 742 can pivot independently of the corresponding leg 710 to allow the support apparatus 700 to remain generally level. In this manner, the base surface 845 of each foot 742 can remain at least partially aligned with the surface that the foot 742 is positioned on and provide a stable base for the support apparatus 700.

FIG. 9 is a cross-sectional side view of a portion of a leg 910 configured in accordance with another embodiment of the invention. Many features of the leg 910 can be at least generally similar in structure and function to corresponding features of the legs 210, 410, 610, 710 described above with reference to FIGS. 2-8. For example, the illustrated embodiment includes a plurality of shaped outer portions 912 (identified individually as a first shaped outer portion 912a, a second shaped outer portion 912b, and a third shaped outer portion 912c) arranged along the core 814 and pivotally coupled to the foot 742. In the illustrated embodiment, however, each of the shaped outer portions 912 is formed individually separate from the adjacent shaped outer portions 912, and an interface 911 separates adjacent shaped portions 912.

According to another feature of the illustrated embodiment, each shaped outer portion 912 includes a plurality of protrusions 916 embedded or otherwise attached thereto. In one embodiment, the protrusions 916 can be formed from a different material than that of the shaped outer portions 912. In other embodiments, however, and as described above, the protrusions 916 can be made from the same materials as the shaped outer portions 912.

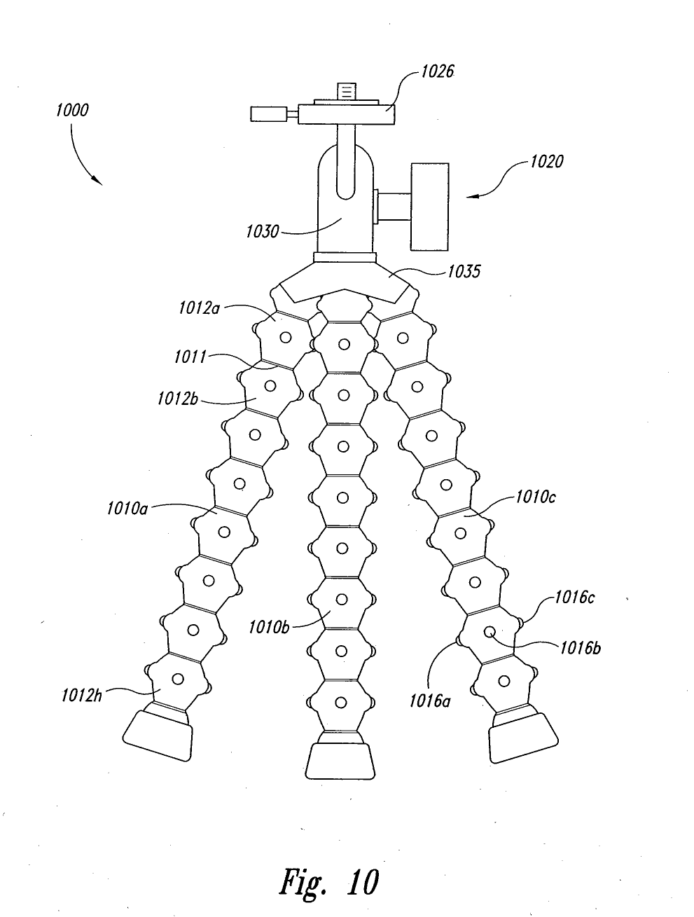

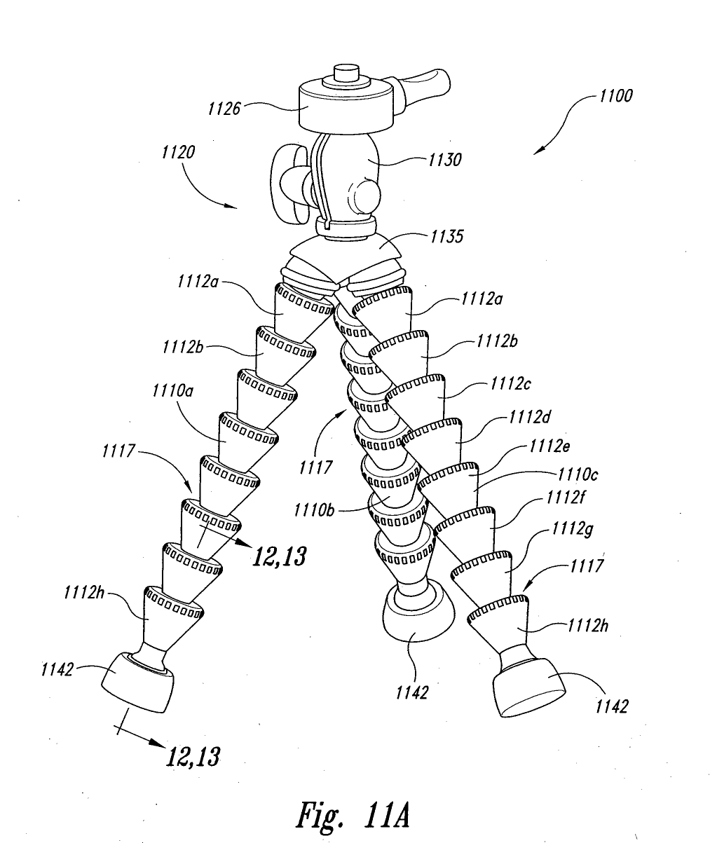

FIG. 10 is a side view of a camera support apparatus 1000 (“support apparatus 1000”) configured in accordance with yet another embodiment of the invention. Many features of the support apparatus 1000 are generally similar in structure and function to corresponding features of the support apparatuses 200, 400, 600, 700 described above with reference to FIGS. 2-9. For example, the support apparatus 1000 includes a camera holding portion 1020 including a base portion 1035. The base portion 1035 supports an adjustable joint 1030 that is operably coupled to an adjustable mounting head 1026. A plurality of legs 1010 (identified individually as a first leg 1010a, a second leg 1010b, and a second leg 1010c) are pivotally coupled to and extend from the base portion 1035. The legs 1010 include a plurality of shaped outer portions 1012, each of which includes a plurality of protrusions 1016 (identified individually as a first protrusion 1016a, a second protrusion 1016b, and a third protrusion 1016c). As described above, in certain embodiments the protrusions 1016 can be formed integrally with the shaped outer portions 1012. In other embodiments, the protrusions 1016 can be formed separately from the shaped outer portions 1012.

According to one feature of the illustrated embodiment, an interface or spacer 1011 separates adjacent shaped outer portions 1012. For example, in the illustrated embodiment, the spacer 1011 is positioned between the first shaped outer portion 1012a and the second shaped outer portion 1012b of the first leg 1010a. In certain embodiments, the spacers 1011 and the shaped outer portions 1012 can be integrally formed from the same material. In other embodiments, however, the spacers 1011 can be separate components from the shaped outer portions 1012.

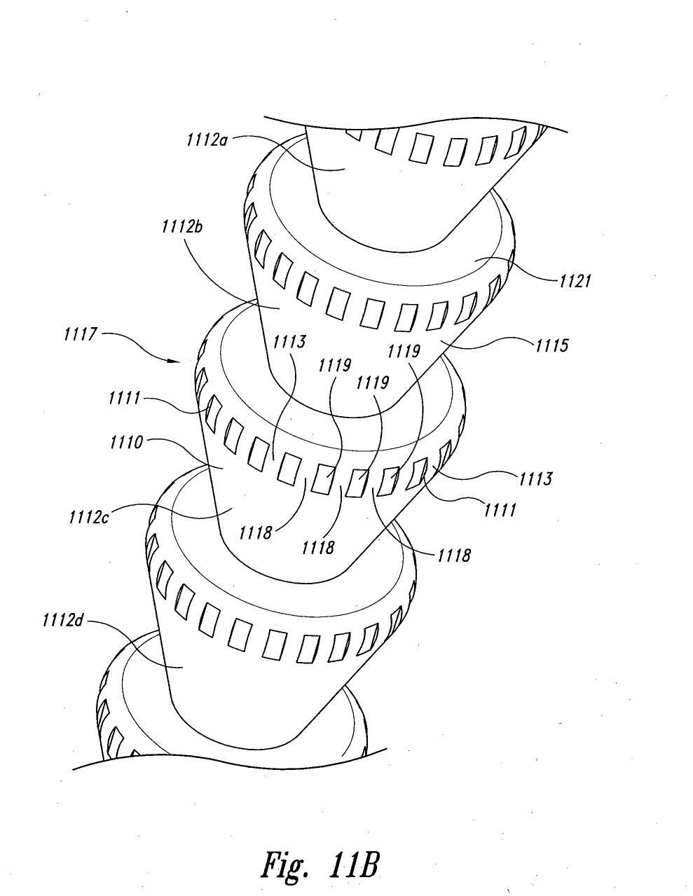

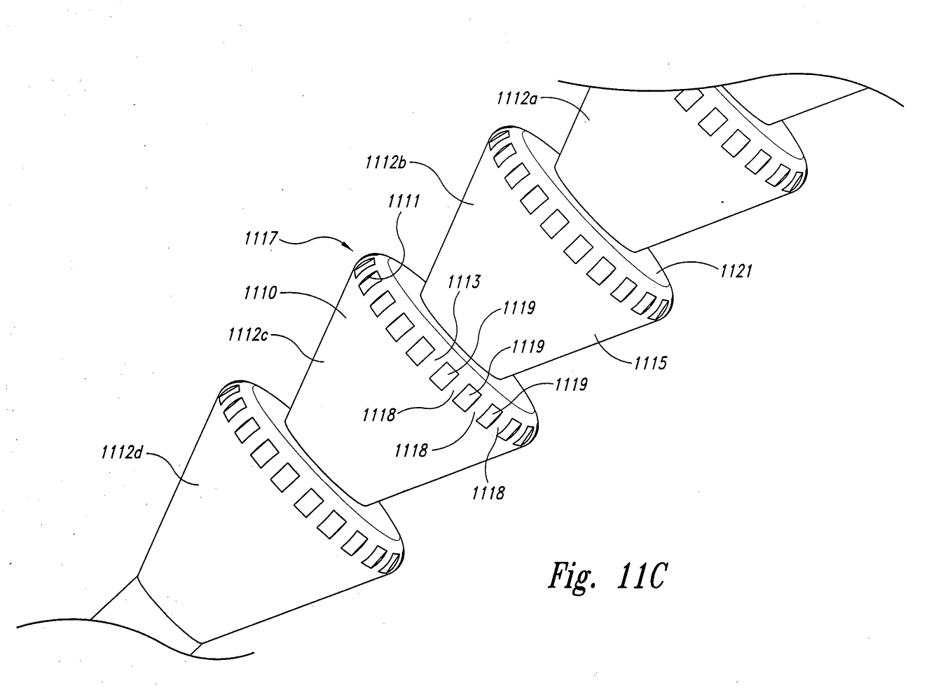

FIG. 11A is an isometric view of a camera support apparatus 1100 (“support apparatus 1100”) configured in accordance with another embodiment of the invention. Many features of the support apparatus 1100 are generally similar in structure and function to corresponding features of the support apparatuses 200, 400, 600, 700, 1000 described above with reference to FIGS. 2-10. For example, the support apparatus 1100 includes a camera holding portion 1120 including a base portion 1135. The base portion 1135 supports an adjustable joint 1130 that is operably coupled to an adjustable mounting head 1126. A plurality of legs 1110 (identified individually as a first leg 1110a, a second leg 1110b, and a third leg 1110c) are pivotally coupled to and extend from the base portion 1135. Each leg 1110 includes a self-leveling support socket or foot 1142. Each leg 1110 also includes a plurality of shaped outer portions 1112 (identified individually as shaped outer portions 1112a-1112h) arranged along an elongate, bendable member or core (not shown in FIG. 11A). According to one aspect of the illustrated embodiment, each shaped outer portion 1112 can be a body of rotation having a generally frusto-conical shape. In other embodiments, however, the shaped outer portions 1112 can include other shapes including, for example, multi-faceted, polygonal, symmetrical, non-symmetrical, irregular shapes, etc. As explained in detail below with reference to FIG. 11B, each shaped outer portion 1112 also includes a gripping edge portion 1117 to facilitate attachment of the support apparatus 1100 to different structures and/or surfaces.

FIGS. 11B and 11C are enlarged views of a portion of one of the legs 1110 of the support apparatus 1100 of FIG. 11A. Referring to FIGS. 11B and 11C together, in the illustrated embodiment each shaped outer portion 1112 includes a generally planar upper portion 1121 and a generally tapering side portion 1115 forming the frusto-conical shape. The gripping edge portion 1117 can be located at the interface between the upper portion 1121 and the side portion 1115. For example, in the illustrated embodiment the gripping edge portion 1117 is located at the widest portion of each shaped outer portion 1112. In other embodiments, however, the gripping edge portion 1117 can be positioned at a mid-portion or other location on each of the shaped outer portions 1112.

In the illustrated embodiment, each gripping edge portion 1117 includes a plurality of spaced-apart gripping features 1118. A notch or recess 1119 is positioned between each of the gripping features 1118 such that the gripping features 1118 project from the corresponding shaped outer portion 1112. In the illustrated embodiment, each gripping feature 1118 has a generally curved exterior surface 1113 positioned between spaced-apart generally planar side surfaces 1111. The alternating gripping features 1118 and recesses 1119 form the generally serrated, dentated, tooth-like, notched, etc. gripping edge portion 1117. In other embodiments, however, the gripping features 1118 can have other shapes suitable for facilitating the gripping function of the shaped outer portions 1112, including, for example, at least partially spherical, rectilinear, polygonal, irregular, and/or other suitable shapes. Moreover, the gripping features 1118 can also be positioned at a different location on the shaped outer portions 1112. In addition, the gripping features 1118 can be combined with shaped outer portions having configurations or shapes different than those shown in the illustrated embodiment. For example, the gripping features 1118 can be combined with any of the shaped outer portions 312, 512, 612, 712, 1012 described above with reference to FIGS. 3-10, or shaped outer portions having different configurations.

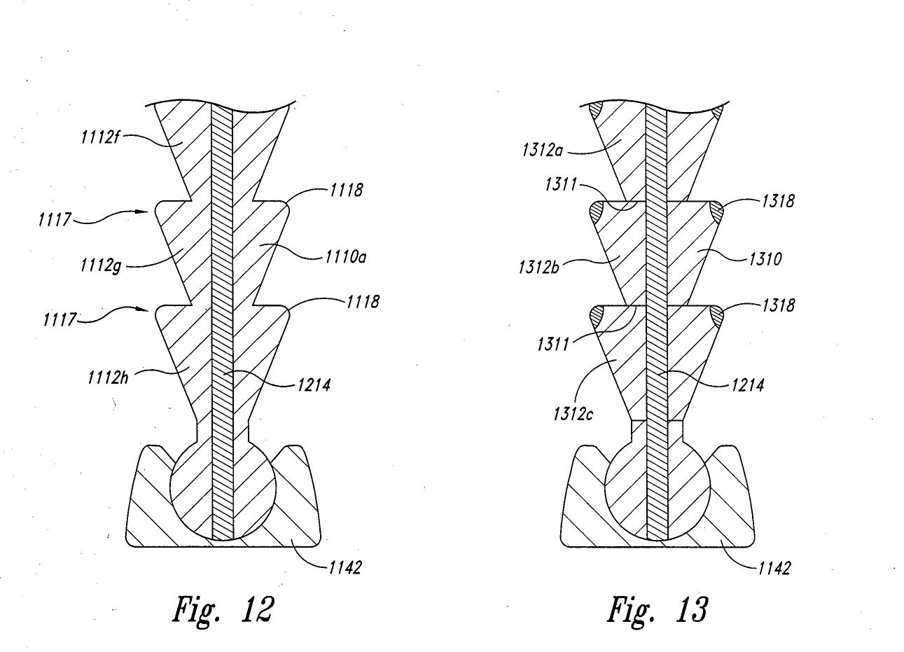

According to another feature of the illustrated embodiment, the shaped outer portions 1112 and the gripping edge portions 1117 can be made from materials configured to enhance the gripping capability of the legs 1110. For example, in certain embodiments, the shaped outer portions 1112 can be formed from rubber, plastics, thermoplastics, elastomers, elastomeric materials, non-elastomeric materials, and/or any combination of these materials. As described below in detail with reference to FIGS. 12 and 13, the gripping features 1118 can be integrally formed with the shaped outer portions 1112, as well as separately formed and embedded, adhered, or otherwise attached to the shaped outer portions 1112.

According to yet another feature of the illustrated embodiment, several of the components of the support apparatus 1100 can be different colors. In the illustrated embodiment, for example, the shaped outer portions 1112, or portions thereof (e.g., the gripping edge portions 1117), can include alternating or contrasting colors. In other embodiments, however, the support apparatus 1100 can be a generally uniform color.

The gripping edge portions 1117 and gripping features 1118 of the illustrated embodiment provide a gripping capability that allows the support apparatus 1100 to be removably attached to different objects. For example, when the legs 1110 are at least partially wrapped around an object (e.g., a bar, tree limb, rock, etc.), the gripping features 1118 enhance the gripping capability of the legs 1110. Moreover, the frusto-conical shaped outer portions 1112 can also improve the gripping capability of the legs 1110. In addition, the gripping edge portions 1117 and gripping features 1118 can provide an improved grip on uneven or irregular surfaces to help stabilize a camera mounted on a variety of different objects or surfaces.

FIG. 12 is a cross-sectional view of a portion of the first leg 1110a taken substantially along lines 12, 13-12, 13 of FIG. 11A. Many features of the first leg 1110 can be at least generally similar in structure and function to corresponding features of the legs 210, 410 610, 710, 910, 1010 described above with reference to FIGS. 2-10. For example, the first leg 1112a is pivotally coupled to the self-leveling foot 1142. The first leg 1112a also includes a bendable member or core 1214 extending through the shaped outer portions 1112. The core 1214 can be formed or bent into a given shape and remain in that shape without appreciable spring-back. Suitable materials for the core 1214 can include, for example, various types of metals such as aluminum (e.g., 1070 aluminum), copper, steel and other known metals of suitable composition, ductility, heat treat, etc. In other embodiments, the core 1214 can be made from other known metal and non-metal materials that can be formed, bent, or otherwise positioned into a given shape and remain in that shape without appreciable spring-back.

According to one aspect of the embodiment illustrated in FIG. 12, the shaped outer portions 1112 are contiguously arranged along the core 1214 and integrally formed (e.g., molded) with each other. The gripping features 1118 are also integrally formed (e.g., molded) with the shaped outer portions 1112. Moreover, in one embodiment the recesses 1119 (FIGS. 11B and 11C) can also be integrally formed (e.g., molded) with the shaped outer portions 1112 and/or gripping features 1118. In other embodiments, however, the recesses 1119 can be formed by removing material from the gripping edge portions 1117 to form the gripping features 1118.

FIG. 13 is a cross-sectional view of a portion of a leg 1310 configured in accordance with another embodiment of the invention. Many features of the leg 1310 can be at least generally similar in structure and function to corresponding features of the legs 210, 410, 610, 710, 910, 1010, 1110 described above with reference to FIGS. 2-12. For example, the illustrated embodiment includes a plurality of shaped outer portions 1312 (identified individually as a first shaped outer portion 1312a, a second shaped outer portion 1312b, and a third shaped outer portion 1312c) arranged along the core 1214 and pivotally coupled to the foot 1142. In the illustrated embodiment, however, each of the shaped outer portions 1312 is formed individually separate from the adjacent shaped outer portions 1312, and an interface 1311 separates adjacent shaped portions 1312. According to another feature of the illustrated embodiment, each shaped outer portion 1312 includes a plurality of gripping features 1318 that are embedded, adhered, or otherwise attached thereto. In one embodiment, for example, the gripping features 1318 can be formed from a different material than that of the shaped outer portions 1312. In other embodiments, however, and as described above, the gripping features 1312 can be made from the same materials as the shaped outer portions 1312.

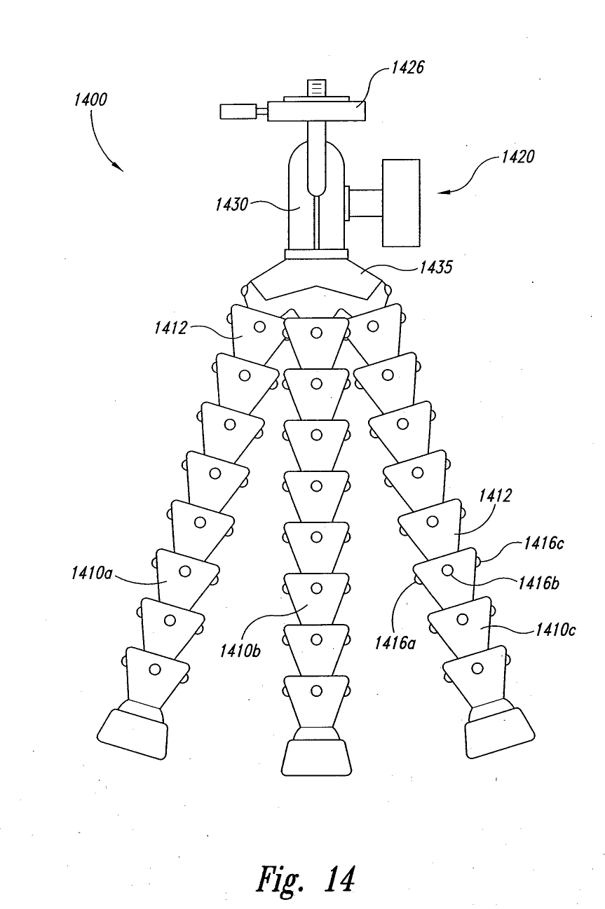

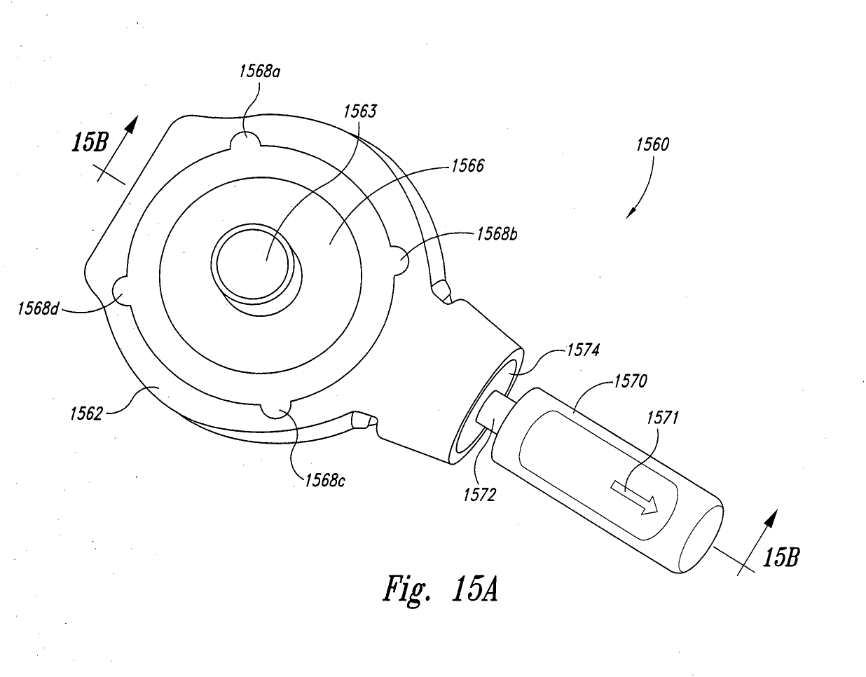

FIG. 14 is a side view of an adjustable camera support apparatus 1400 (“support apparatus 1400”) configured in accordance with yet another embodiment of the invention. Many features of the support apparatus 1400 are generally similar in structure and function to corresponding features of the support apparatuses 200, 400, 600, 700, 1100 described above with reference to FIGS. 2-13. For example, the support apparatus 1400 includes a camera holding portion 1420 including a base portion 1435. The base portion 1435 supports an adjustable joint 1430 that is operably coupled to an adjustable mounting head 1426. A plurality of legs 1410 (identified individually as a first leg 1410a, a second leg 1410b, and a third leg 1410c) are pivotally coupled to and extend from the base portion 1435.

According to one aspect of the illustrated embodiment, each of the legs 1410 includes a plurality of shaped outer portions 1412. Each of the shaped outer portions 1412 has a generally frusto-conical shape and includes a plurality of bumps or protrusions 1416 (identified individually as a first protrusion 1416a, a second protrusion 1416b, and a third protrusion 1416c) extending from an exterior surface thereof. In the illustrated embodiment, the protrusions 1416 are located at a position slightly offset from a generally planar upper portion 1417 of each shaped outer portion 1412. In other embodiments, however, the protrusions 1416 can be positioned at other locations on the shaped outer portions 1412. For example, the protrusions 1416 can be centered on the shaped outer portions 1412, generally aligned with the upper portion 1417, randomly positioned, etc. The protrusions 1416 can be generally similar in structure and function to the protrusions 716, 916, 1016 described above with reference to FIGS. 7A-10. For example, the protrusions can have a generally hemispherical shape and can be formed integrally with the shaped outer portions 1412 and/or be formed separately from the shaped outer portions 1412.

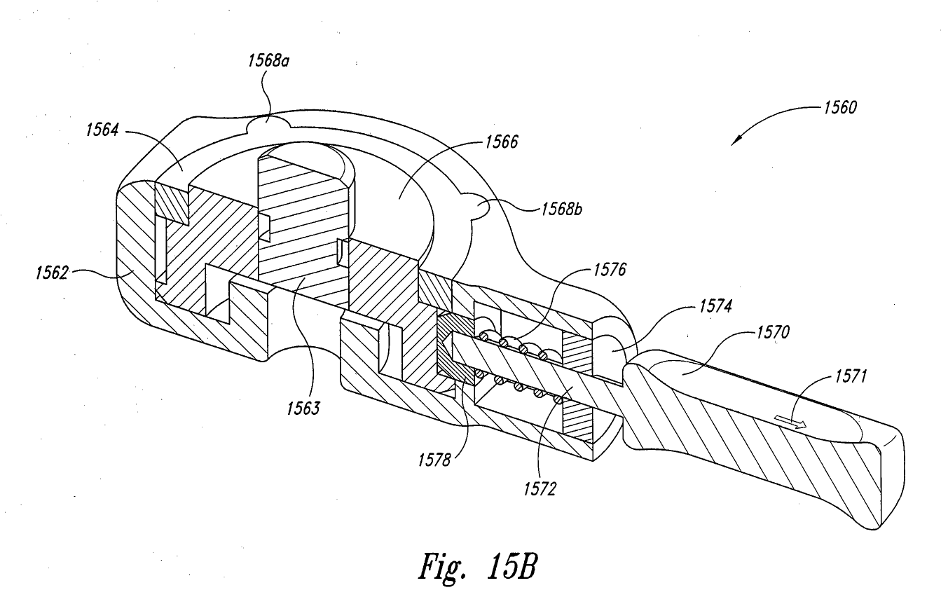

FIG. 15A is an isometric view and FIG. 15B is an isometric cross-sectional view taken substantially along lines 15B-15B of FIG. 15A of an adjustable mounting head 1560 configured in accordance with an embodiment of the invention. Referring to FIGS. 15A and 15B together, many features of the mounting head 1560 are generally similar in structure and function to corresponding features of the mounting heads 226, 526, 726, 1026, 1426 described above with reference to FIGS. 2-14. For example, the mounting head 1560 includes a threaded stud 1563 for attachment to a camera or other equipment, and a release member 1570 to rotationally lock the mounting head 1560 in place.

In the illustrated embodiment, however, the mounting head 1560 includes a body 1562 that carries a first support member 1564. The first support member 1564 is operably coupled to and carries a second support member 1566 attached to the threaded stud 1563. More specifically, the first support member 1564 generally encompasses and is rotatable with reference to the second support member 1566. The first support member 1564 includes a plurality of engagement features 1568 (identified individually as a first-fourth engagement features 1568a-1568d). The engagement features 1568 interconnect or otherwise engage the body 1562 such that the body 1562 rotates with the first support member 1564 around the second support member 1566.

The release member 1570 is operably coupled to the body 1562 with a shaft 1572 extending through a collar 1574 carried by an extension of the body 1562. A biasing member 1576 (e.g., a compression spring) is positioned over the portion of the shaft 1572 received in the body 1562. An end portion of the shaft 1572 is operably coupled to a locking member 1578, and the biasing member 1576 urges the locking member 1578 toward the second support member 1566. In certain embodiments, the second support member 1566 includes receiving features (not shown) that can engage or otherwise at least partially receive the locking member 1578 in different rotational positions. In certain embodiments, the receiving features of the second support member 1566 can include recesses, detents, stops, etc. These receiving features can stop the rotation and/or provide discreet increments of rotation for the first support member 1564 and body 1562 about the second support member 1562.

In operation, a user can pull the release member 1570 away from the body 1562 in the direction indicated by arrow 1571. Pulling the release member 1570 in this direction moves the locking member 1578 away from the second support member 1566 to allow the first support member 1564 and the body 1562 to rotate about the second support member 1566. When the user releases the release member 1570, the biasing member 1576 urges the locking member 1578 toward the second support member 1566. As the locking member 1578 is biased against the second support member 1566, the locking member 1578 can rotate with the first support member 1564 and body 1562 about the second support member 1566 until the locking member 1578 engages one of the receiving features in the second support member 1566. In this manner, the mounting head 1560 can provide convenient incremental rotational adjustment of a camera supported by the mounting head 1560.

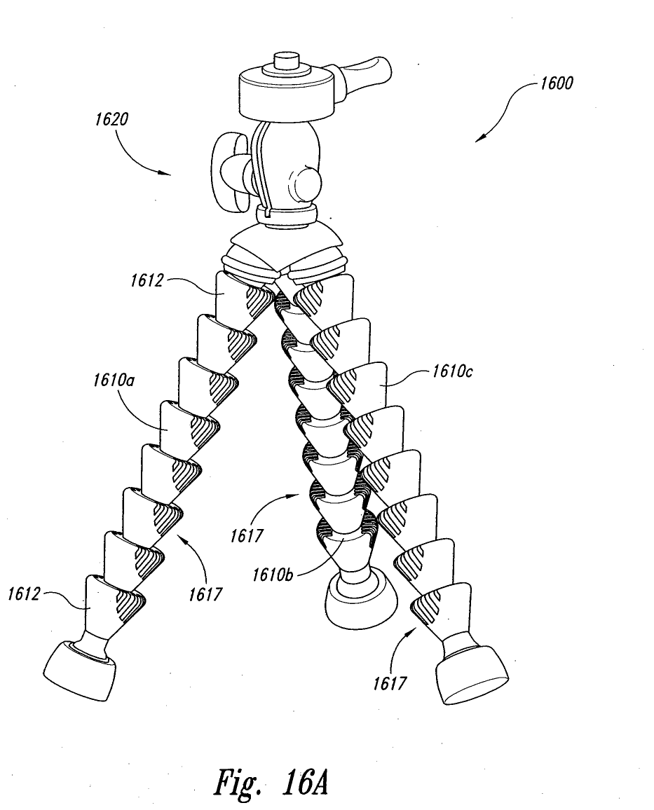

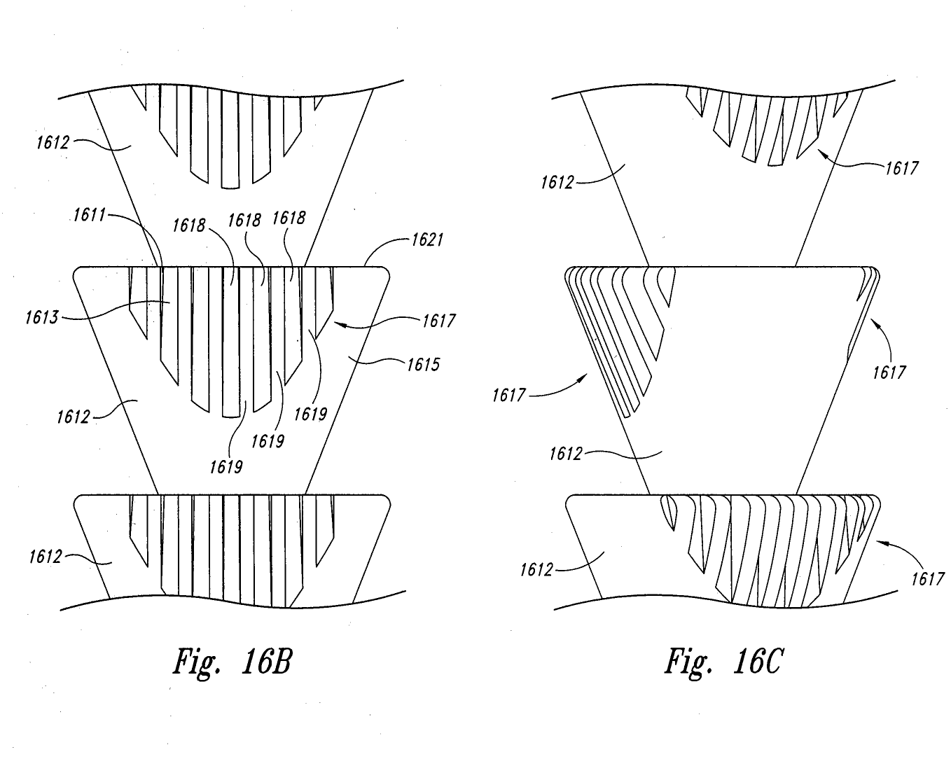

FIG. 16A is an isometric view of an adjustable camera support apparatus 1600 (“support apparatus 1600”) configured in accordance with another embodiment of the invention. Many features of the support apparatus 1600 are generally similar in structure and function to corresponding features of the support apparatuses 200, 400, 600, 700, 1000, 1100, 1400 described above with reference to FIGS. 2-15B. For example, the support apparatus 1600 includes a plurality of legs 1610 (identified individually as a first leg 1610a, a second leg 1610b, and a third leg 1610c) extending from a camera holding portion 1620.

Each leg 1610 includes a plurality of shaped outer portions 1612 arranged along an elongate, bendable member or core (not shown in FIG. 16A). In certain embodiments, each shaped outer portion 1612 can be a body of rotation having a generally frusto-conical shape. In other embodiments, however, the shaped outer portions 1612 can include other shapes including, for example, multi-faceted, polygonal, symmetrical, non-symmetrical, irregular, etc. As explained in detail below with reference to FIGS. 16B and 16C, each shaped outer portion 1612 includes one or more gripping edge portions 1617 to enhance the gripping capability of the support apparatus 1600. According to one aspect of the illustrated embodiment, the gripping edge portions 1617 can be positioned at generally opposite positions on each shaped outer portion 1612. In other embodiments, however, the gripping edge portions 1617 can be positioned at other locations, including, for example, gripping edge portions extending completely around, positioned uniformly or randomly around, more than two gripping edge portions spaced around each shaped outer portion 1612, etc. In the illustrated embodiment, the gripping edge portions 1617 are integrally connected to the shaped outer portions 1612. In other embodiments, however, the gripping edge portions 1617 can be adhered, bonded, or otherwise connected to the shaped outer portions 1612.

FIG. 16B is an enlarged side view of a portion of a leg 1610 of the camera support 1600 of FIG. 16A configured in accordance with one embodiment of the invention. In the illustrated embodiment, each shaped outer portion 1612 includes a generally planar upper portion 1621 and a generally tapering side portion 1615 forming the frusto-conical shape. The gripping edge portion 1617 includes a plurality of spaced-apart gripping features 1618 formed by recesses 1619 positioned between adjacent gripping features 1618. According to one aspect of the illustrated embodiment, each gripping feature 1618 includes an exterior surface 1613 that generally matches the shape of the tapering side portion 1615 of each shaped outer portion 1612.

According to another feature of the illustrated embodiment, the gripping edge portion 1617 has a generally V-shaped or triangular configuration. More specifically, the gripping edge portion 1617 includes a central gripping feature 1618a. In the illustrated embodiment, the central gripping portion 1618a has the greatest length extending from the upper portion 1621 of the gripping features 1618. The surrounding gripping features 1618 have gradually decreasing lengths extending laterally from the central gripping feature 1618a thereby forming the V-shaped configuration of the gripping edge portion 1617. In other embodiments, however, the gripping edge portion 1617 can include other shapes and/or configurations, including for example, gripping features 1618 each having the same approximate length.

Another feature of the illustrated embodiment is that each recess 1619 has a varying depth extending from the side portion 1615 to the upper portion 1621. More specifically, the recesses 1619 include a greatest depth near the middle of the gripping edge portion 1617 proximate to the upper portion 1621. As a result, the gripping features 1618 (e.g., the central gripping feature 1618a) near the middle of the gripping edge portion 1617 may be slightly more flexible than the gripping features 1618 positioned at the sides of the gripping edge portion 1617. In other embodiments, however, the recesses 1619 can include other configurations, including for example, a generally constant depth extending alongside the gripping features 1618.

FIG. 16C is an enlarged side view of a portion of a leg 1610 of the camera support 1600 of FIG. 16A configured in accordance with another embodiment of the invention. In the embodiment illustrated in FIG. 16C, the adjacent shaped outer portions 1612 are configured such that their respective gripping edge portions 1617 are aligned in an alternating configuration. More specifically, the gripping edge portions 1617 upper and lower shaped outer portions 1612 are generally aligned with each other. The gripping edge portion 1617 of the middle shaped outer portion 1612, however, is rotated relative to the gripping edge portions 1617 of the adjacent shaped outer portions 1612.

From the foregoing, it will be appreciated that specific embodiments of the invention have been described herein for purposes of illustration, but that various modifications may be made without deviating from the spirit and scope of the various embodiments of the invention. For example, the gripping features, protrusions, etc. can be used with shaped outer portions having various shapes and configurations, including those described above with reference to FIGS. 2-16C, as well as other shapes and configurations.

Moreover, while various embodiments of the present invention have been described above in the context of a camera support, those of ordinary skill in the art will appreciate that various features of the present invention are equally well suited for use in supporting and positioning other types of equipment, such as sound equipment, video display equipment, lighting equipment, etc. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. An apparatus for supporting a camera, the apparatus comprising:
an adjustable camera holding portion configured to releasably engage a camera; and
a plurality of formable legs, wherein each of the formable legs includes:
a first end portion operably coupled to the cameral holding portion and a second end portion spaced apart from the first end portion;
a plurality of shaped portions contiguously arranged between the first and second end portions, wherein each of the shaped portions includes a plurality of gripping features on an exterior surface thereof; and
an adjustable foot pivotally coupled to the second end portion.

2. The apparatus of claim 1, wherein each leg further includes an elongate bendable member extending from the first end portion to the second end portion, wherein each of the shaped portions surrounds the elongate bendable member.

3. The apparatus of claim 2 wherein the elongate bendable member includes a material that retains its shape after forming.

4. The apparatus of claim 1 wherein each of the shaped portions has a generally frusto-conical shape.

5. The apparatus of claim 1 wherein each of the gripping features has a generally curved exterior surface and spaced apart generally planar side surfaces.

6. The apparatus of claim 1 wherein the gripping features are equally spaced apart along a gripping edge portion of each of the shaped portions.

7. The apparatus of claim 1 wherein the gripping features are integrally formed with the corresponding shaped portions.

8. The apparatus of claim 1 wherein each of the shaped portions includes a resilient material and each of the gripping features includes a resilient material.

9. The apparatus of claim 1 wherein the adjustable foot includes a generally planar base surface.

10. The apparatus of claim 1 wherein the adjustable foot includes a socket cavity configured to receive a shaped extension of the second end portion.

11. A portable apparatus for supporting a piece of equipment, the apparatus comprising:
an equipment holding portion; and
a plurality of bendable support members, wherein each of the bendable support members includes:
a proximal end portion operably coupled to the equipment holding portion;
a distal end portion extending away from the equipment holding portion; and
a plurality of shaped portions sequentially arranged between the proximal and distal end portions, wherein each of the shaped portions includes a gripping edge portion having a plurality of alternating gripping features and recesses.

12. The apparatus of claim 11 wherein each of the shaped portions and corresponding gripping features are integrally formed from a resilient material.

13. The apparatus of claim 11 wherein the gripping edge portion has a generally serrated shape formed by the gripping features and the recesses.

14. The apparatus of claim 11 wherein each of the bendable support members further includes a bendable core extending from the proximal end portion to the distal end portion through each of the shaped portions.

15. The apparatus of claim 14 wherein the shaped portions are formed from a resilient material contiguously arranged on the bendable core.

16. The apparatus of claim 11 wherein the equipment holding portion includes and adjustable camera mounting head configured to rotate a camera supported by the mounting head, wherein the mounting head includes a release member configured to lock the mounting head in multiple incremental rotational positions.

17. The apparatus of claim 11 wherein the gripping edge portion has a generally V-shaped configuration.

18. A camera supporting apparatus comprising:
an adjustable camera holding portion configured to releasably engage a camera; and
a plurality of bendable support members, wherein each of the bendable support members includes:
a proximal end portion operably coupled to the camera holding portion;
a distal end portion extending away from the camera holding portion;
a bendable core member extending between the proximal and distal end portions;
a plurality of shaped outer portions sequentially arranged along the bendable core, wherein each of the shaped outer portions has a generally frusto-conical shape including a gripping edge portion at the widest portion thereof; and
a foot pivotally coupled to the distal end portion, wherein the foot includes a self-leveling support surface.

19. The apparatus of claim 18 wherein the foot includes a partially spherical cavity that receives a corresponding generally spherical extension of the distal end portion, and wherein the spherical extension is pivotable in the cavity.

20. The apparatus of claim 18 wherein the foot includes a slanted surface configured to accommodate a generally straight portion extending between the distal end portion and the spherical extension during relative movement between the foot and the distal end portion.

21. The apparatus of claim 18 wherein each of the gripping edge portions include external means for gripping an object.
